(19) United States
(12) Patent Application Publication
(10) Pub. No.: US 2010/0313150 A1
(43) Pub. Date: Dec. 9, 2010

(54) SEPARABLE DISPLAYS AND COMPOSABLE SURFACES

(75) Inventors: Meredith J. Morris, Bellevue, WA (US); Steven N. Bathiche, Kirkland, WA (US); Stephen Edward Hodges, Cambridge (GB); Ian C. LeGrow, Redmond, WA (US); Victor Kevin Russ, Seattle, WA (US); Ian M. Sands, Redmond, WA (US); William J. Westerinen, Sammamish, WA (US); John Christopher Whytock, Seattle, WA (US); Andrew D. Wilson, Seattle, WA (US); David Alexander Butler, Cambridge (GB); Shahram Izadi, Cambridge (GB)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/477,426

(22) Filed: Jun. 3, 2009

(51) Int. Cl. G06F 3/00

(52) U.S. Cl. 715/761

(57) ABSTRACT

The claimed subject matter relates to a display that is physically separable and to an associated architecture that can facilitate data mobility or collaboration in connection with the separable display. In particular, the separable display can be configured as an apparent unitary or singular UI for an associated multi-node computer, yet for which portion of the separable display can be physically decoupled. The multi-node computer can include a set of computing nodes, each of which can potentially operate autonomously, yet also in unison with other nodes to form a collective multiprocessor computing platform. Moreover, each of the computing nodes can be embedded in and distributed throughout the separable display. Accordingly, when a portion of the separable display is decoupled from a remainder of the separable display, both the portion and the remainder can include some subset of the computing nodes, and can therefore maintain the UI.

### BACKGROUND

Today, most computing devices, whether stationary or mobile device, utilize some form of display screen or surface as a user-interface (UI) component. Often these displays are merely output only devices, while a growing number utilize touch-sensitive screens for interactivity and/or input functionality. Recent technological advances both in terms of user-interfaces as well as display surfaces have sparked a growing evolution toward surface computing. In the domain of surface computing, the associated displays are generally touch-sensitive screens of substantially any form factor that often forego many traditional I/O devices such as a keyboard or mouse in favor of tactile-based manipulation.

In a related field, recent technological advances have also led to cheaper displays, some of which can be flexible or malleable, or even in the form of a fabric. Due to the wide proliferation of computing devices with display screens as well as the many new types of display surfaces or materials, new techniques or technologies can be implemented or leveraged in order to enhance functionality, increase productivity, and/or enrich user experiences.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one or more aspects thereof, comprises a display that is physically divisible. In accordance therewith and to other related ends, a separable display can be provided that is configured as a user-interface (UI) for an associated multi-node computing architecture. The computing architecture can include a plurality of computing nodes, each of which can be physically embedded within the display and thus dispersed throughout substantially all regions of the display.

Moreover, each computing node can be configured to function as an autonomous computing unit even though typical operation can involve other computing nodes that are physically coupled (e.g., by way of coupled portions of the separable display) and, thus, comprise the multi-node computing component. Furthermore, each computing node can be further configured to manage UI transactions and/or I/O transactions associated with a respective local region of the separable display, e.g. the local region proximal to a location in which a given computing node is embedded.

Generally, each computing node can include a processor, a memory store, and one or more components that can identify other physically coupled computing nodes as well as various attributes associated with other computing nodes such as capabilities, memory or data sets, authorizations, assignments, or licenses, spatial geometry or the like

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a computer-implemented system that depicts a display that can be physically divisible.

FIG. 2 depicts a block diagram of a computer-implemented system that can facilitate data mobility and/or collaboration in connection with a separable display.

FIG. 3 is a block diagram of a computer-implemented system that illustrates various examples in association with facilitating data mobility in connection with a decomposable display.

FIGS. 4A and 4B depict block diagrams of computer-implemented systems that illustrate additional features or aspects relating to operable power sources and/or temporary powerless operation.

FIG. 5 depicts an exemplary flow chart of procedures that define a method for providing a decomposable display.

FIG. 6 illustrates an exemplary flow chart of procedures that define a method for facilitating data mobility or collaboration in connection with a decomposable display.

FIG. 7 depicts an exemplary flow chart of procedures defining a method for structuring a power supply for the separable display or portions thereof.

FIG. 8 illustrates a block diagram of a computer-implemented system that can facilitate dynamic composition of multiple disparate display surfaces.

FIG. 9A is a diagram 900, illustrating an example of adjacent displays.

FIG. 9B depicts a diagram 910, illustrating an example of overlapping displays.

FIG. 9C illustrates a diagram 920, illustrating an example of proximal displays.

FIG. 10 is a block diagram of a system that can determine display surface geometry in a variety of ways.

FIG. 11 illustrates a block diagram of a computer-implemented system that can maintain a set of capabilities for all connected devices.

FIG. 12 depicts a block diagram of a system that can facilitate transition of objects and related data between displays and associated devices.

FIG. 13 is a block diagram of a system that can provide for or aid with various inferences or intelligent determinations.

FIG. 14 depicts an exemplary flow chart of procedures that define a method for facilitating dynamic composition of multiple disparate display surfaces is.

FIG. 15 illustrates an exemplary flow chart of procedures that define a method for providing additional features in connection with dynamic composition of multiple disparate display surfaces.

FIG. 16 depicts an exemplary flow chart of procedures defining a method for providing additional aspects or feature associated with capabilities and transitions.

FIG. 17 illustrates a block diagram of a computer operable to execute the disclosed architecture.

FIG. 18 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can, but need not, refer to a computer-related entity, either hardware, a combination of hardware and software, software, or software in execution. For example, a component might be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” Therefore, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” generally refer to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

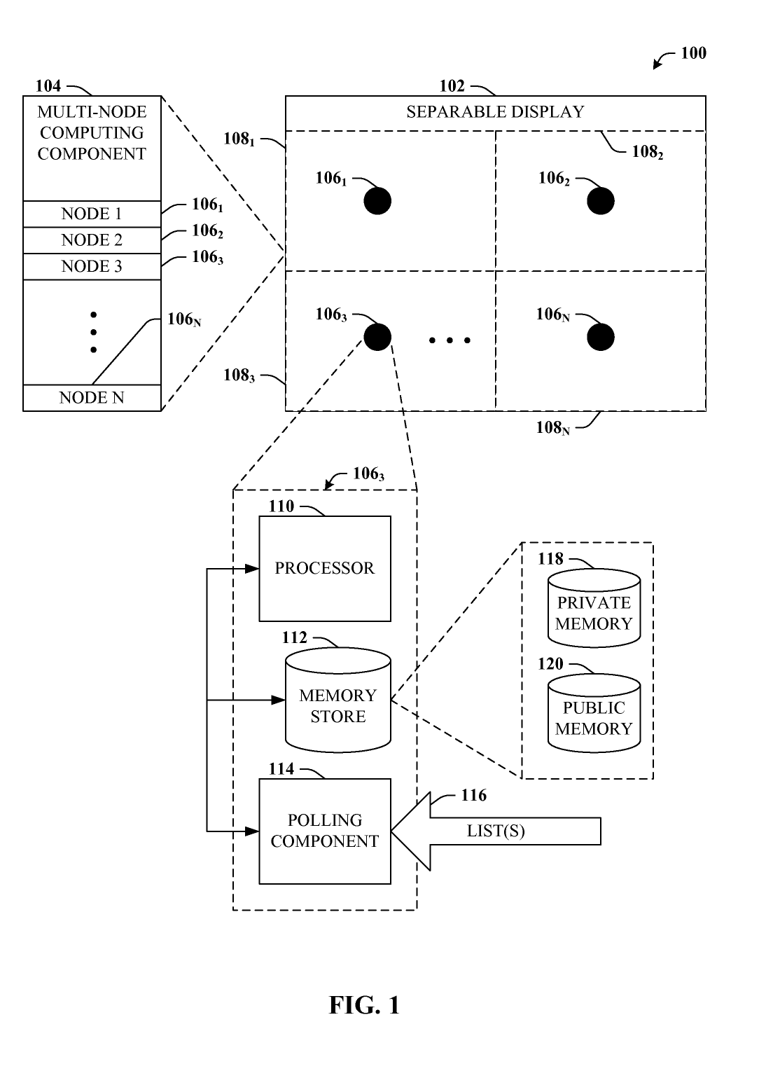

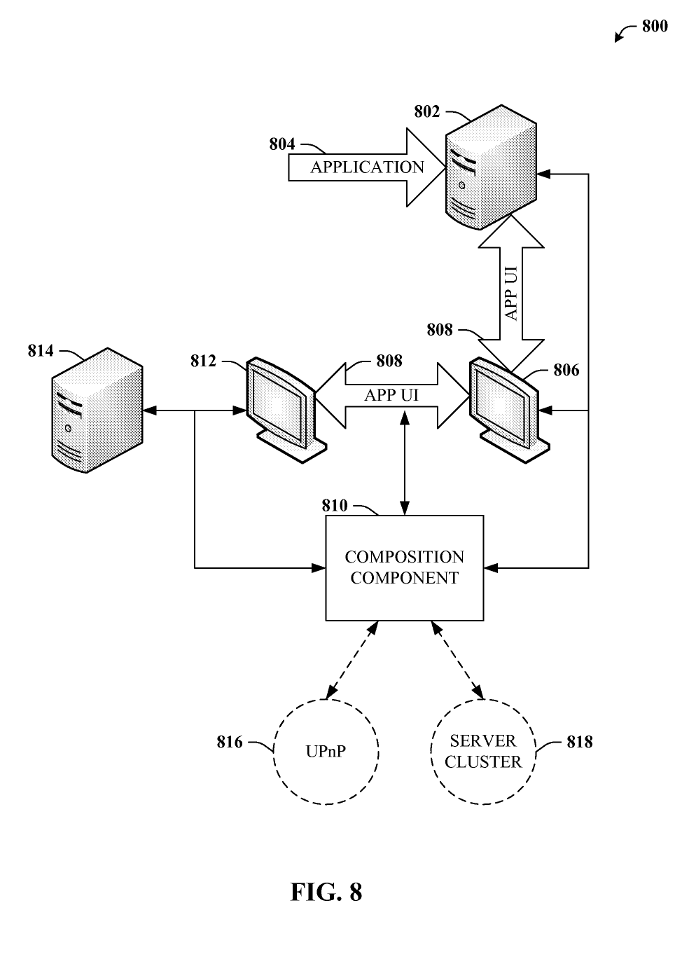

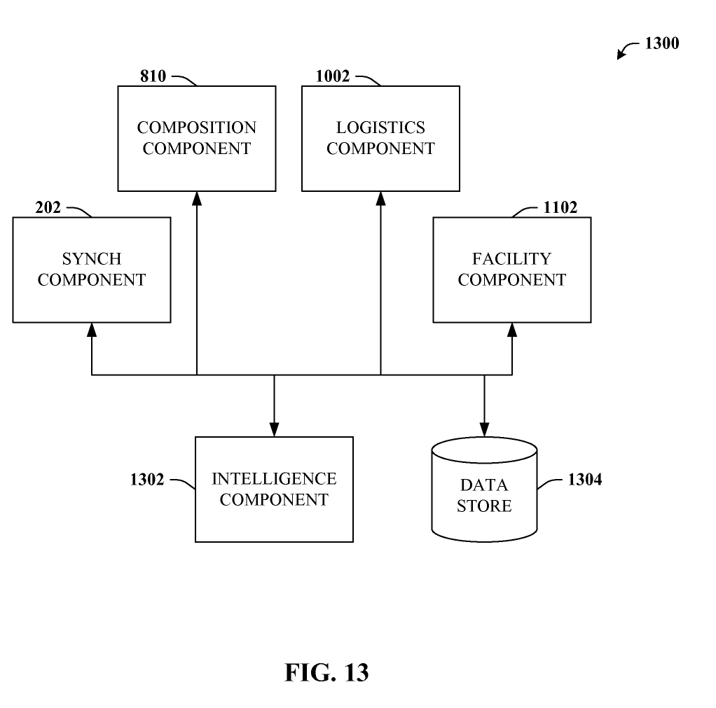

As an introductory guideline, it should be noted that FIGS. 1-7 particularly relate to separable displays, whereas FIGS. 8-12 and 14-16 are directed toward composable surfaces, and FIGS. 13, 17, and 18 are intended to apply at least in part to both sections. Accordingly, it should be understood that discussion directed to composable surfaces can be applicable to composition of separable displays as discussed herein (e.g., re-coupling decoupled portions of the separable display), or can apply more broadly to other types of displays or surfaces.

### Separable Displays

Referring now to the drawings, with reference initially to FIG. 1, computer-implemented system 100 that depicts a display that can be physically divisible. In particular, system 100 relates to separable display 102 that can be configured as a user-interface (UI) for an associated multi-node computing component 104. Multi-node computing component 104 can consist of a plurality of individual computing nodes 106₁-106_{N}, wherein N can be substantially any positive integer. Computing nodes 106₁-106_{N} are generally referred to herein, either collectively or individually as computing node(s) 106 or the plurality of nodes 106, with subscripts typically only used to avoid confusion or when needed to illustrated various distinctions or examples.

The plurality of computing nodes 106 can be included in or embedded in separable display 102. Moreover, each of the computing nodes 106 can be distributed throughout separable display 102 at various locations that can be organized or structured based upon pre-formatted separation boundaries, based upon likely or common separation boundaries, based upon suitability for substantially any separation boundaries, or the like. Regardless, each computing node 106 can be responsible for managing UI transactions associated with a location region 108₁-108_{N} of separable display 102 that is local to the associated computing node 106. In other words, UI transactions (e.g., I/O transactions such as rendering graphics or a mouse or cursor click) that occur or originate or relate to a particular region 108 can be handled by the associated computing node 106 that is responsible for that physical space of separable display 102. For instance, computing node 106₁ can render graphics or receive inputs when such UI transactions relate to region 108₁; computing node 106₂ can render graphics or receive inputs when such UI transactions relate to region 108₂; and so on.

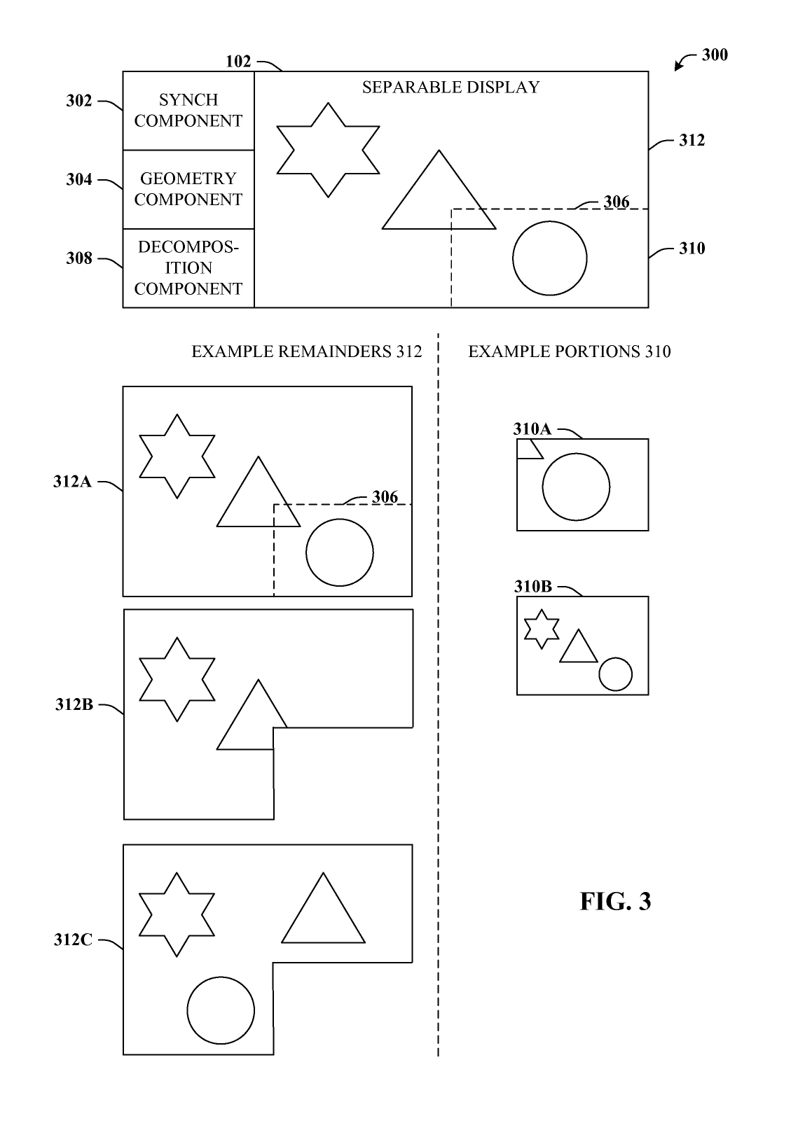

In accordance with the claimed subject matter, it should be appreciated that although potentially existing in a state of a single, seamless or visibly discrete display, separable display 102 can be physically divided which is discussed in more detail with reference to FIG. 3. To provide such functionality, separable display 102 can be constructed from a “tearable” fabric or structured as a seamless, pre-perforated surface. Accordingly, computing nodes 106 can be configured to operate in unison with other computing nodes 106 included in the plurality of nodes 106, yet also to operate as an autonomous computing unit that manages the associated region 108 alone or in tandem with only a subset of the plurality of nodes 106.

Hence, as depicted in FIG. 1 (e.g., in connection with computing node 106₃), each computing node 106 can include one or more associated processors 110 that can execute instructions in connection with multi-node computing component 104. In addition, each computing node 106 can include one or more associated memory stores 112, polling component 114, as well as other components detailed herein or otherwise suitable for inclusion in computing node 106 such as power sources, additional I/O components, applications or operating systems, or the like. Moreover, due to physical separations of region 108 or other physical portions of separable display 102, computing nodes 106 comprising multi-node computing component 104 and/or physically coupled to any given computing node 106 can change.

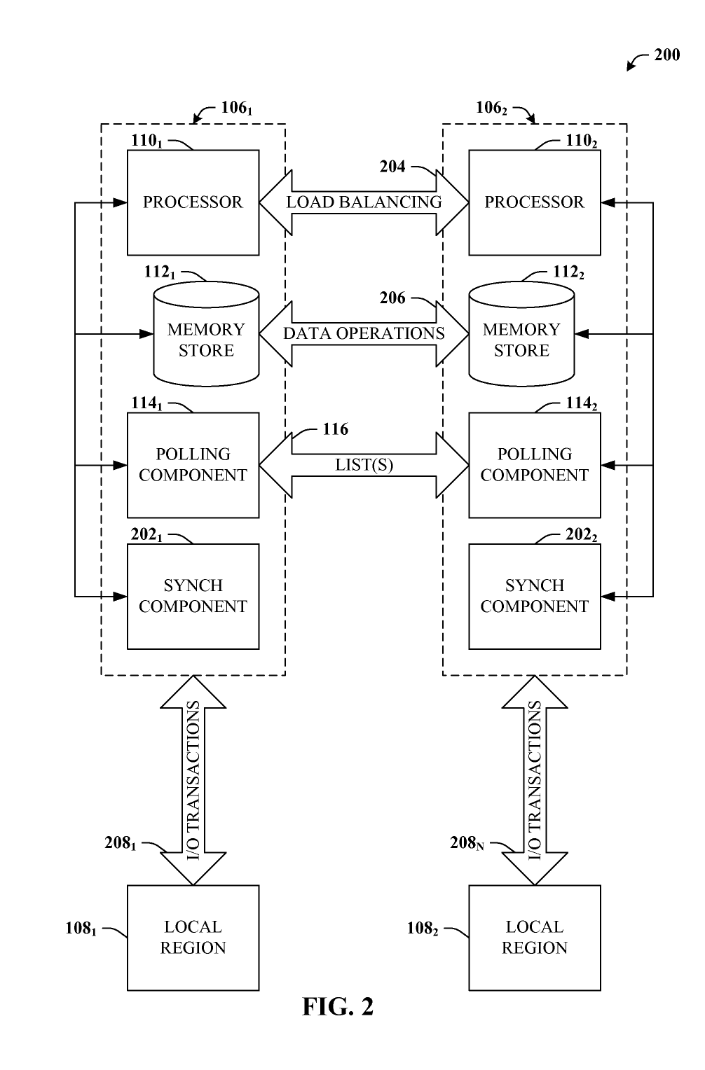

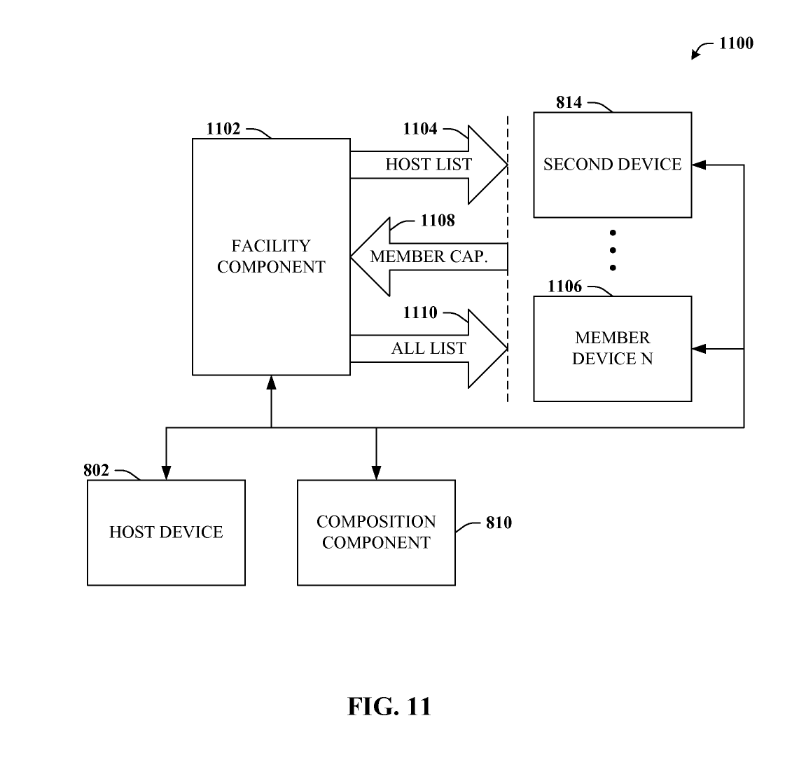

Therefore, it should be appreciated that polling component 114 can be configured to identify physically coupled computing nodes 106, which can be accomplished by way of acknowledgement messages or lists 116. Lists 116 can relate to other types of lists as well directed to additional types of information over membership, which is further discussed in connection with FIGS. 2 and 11 (e.g., lists 1104, 1108, 1110), any or all of which can be received (or transmitted) in whole or in part by polling component 114. Moreover, it should also be appreciated that memory store 112 can be apportioned for specific uses. In particular, memory store 112 can include private memory 118 that is specific to an associated computing node 106 or the associated local region 108 of separable display 102. In addition, memory store 112 can include public memory 120 that can be addressable by or accessible to disparate processors 110 associated with multi-node computing component 104 and/or computing nodes 106 that are physically coupled. Private memory 118 and public memory 120 can be implemented as different portions of a single memory bank or device or can exist as distinct memory banks or devices, potentially at distinct physical locations and/or coupled to distinct buses or the like. Additional detail in connection with memory 112 can be found with reference to FIG. 2. It should be further appreciated that multi-node computing component 104 can be distributed processing device that utilizes well-known or otherwise suitable multiprocessing techniques or technologies.

Turning now to FIG. 2, system 200 that can facilitate data mobility in connection with a separable display is illustrated. System 200 depicts two example computing nodes, node 106₁ and 106₂. Each computing node 106 illustrated includes an associated processor 110 (e.g., processors 110₁ and 110₂), an associated memory store 112 (e.g. memory stores 112₁ and 112₂), and an associated polling component 114 (e.g., polling components 114₁ and 114₂) as substantially described supra. In addition, each computing node 106 can include an associated synchronization component, denoted here as synch components 202₁ and 202₂. Synch components 202 can, inter alia, manage numerous types of communication or operations associated with computing nodes 106 that interact with and/or are physically coupled to other computing nodes 106, which can now be described in more detail.

As discussed previously, each computing node 106 can be responsible for managing UI transactions and/or I/O transactions 208 in connection with an associated local region 108. Typically, for computing node 106₁ to interact with computing node 106₂, local region 108₁ will be physically coupled to local region 108₂, either directly or indirectly. In other words, separable display 102 will include both local regions 108₁ and 108₂ in a continuous surface, whether or not local regions 108₁ and 108₂ are adjacent to one another or have other local regions 108 in between. Consequently, should local region 108₁ be physically severed from local region 108₂, then interaction between computing node 106₁ and 106₂ is effectively terminated, or at least cannot be accomplished by the stated means, but can be accomplished by way of wireless transactions, which are discussed further in connection with FIG. 8. However, as detailed, the interactions described herein are intended to relate specifically to computing nodes 106 that are physically coupled, yet to account for the possibility that such computing nodes 106 will at some time be decoupled. Thus, such wireless communication is not in many cases necessary.

In addition to discovering physically coupled computing nodes 106 as discussed previously, polling component 114 can further identify capabilities of physically coupled computing nodes 106. Discovered capabilities can include, e.g. memory that is shared, sources of power, as well as enumerated I/O capabilities discussed infra in connection with FIGS. 8 and 11. Appreciably, universal plug and play (UPnP) or another suitable technology or technique can be employed for discovering capabilities. Furthermore, in one or more aspects of the claimed subject matter, polling component(s) 114 can also identify a physical geometry of other physically coupled computing nodes 106. In other words, polling component 114 can determine locations within separable display in which other physically coupled computing nodes 106 exist. In a similar vein, polling component 114 can further identify respective local regions 108 in which other physically coupled computing nodes 106 respectively manage. For example, polling component 114 can determine the size and shape of the regions of separable display 102 that are controlled by other physically coupled computing nodes 106.

Moreover, polling component 114 can also identify when a particular computing node 106 is physically decoupled, which is further discussed in connection with FIG. 3. Appreciably, polling component 114 can detect the above-mentioned information by way of messages or lists 116 transmitted from disparate polling components 114 or, particularly in the case of identifying a decoupled computing node 106, by a lack of an acknowledgement or heartbeat. Regardless, when a certain computing node 106 is physically decoupled, polling component 114 can therefore identify or readily determine capabilities or physical geometry associated with the physically decoupled computing node 106 as well as a local region 108 that is the responsibility of that physically decoupled computing node 106.

Hence, consider the case in which the physical decoupling of computing node 106 occurs due to a separation (e.g. division boundaries 306 discussed infra) that differs from boundaries associated with a local region 108 for the decoupled computing node 106. In that case, polling component 114 can be appraised of this situation and can determine that other computing nodes 106, at least those that were previously adjacent to the decoupled computing node 106, might need to adjust the size, shape, and/or dimensions of their own respective local regions 108. It should be understood that in some cases, local regions 108 can be configured in accordance with pre-formatted and/or known perforations of separable display 102. In those cases, physical decoupling of a particular computing node 106 will generally not entail re-defining local regions 108 for other computing nodes 106.

Next to be described in more detail, synchronization component(s) 202 can facilitate load balancing 204 and/or processor load or utilization distribution or normalization. In particular, load balancing 204 can be with respect to processor 110₁ associated with computing node 106₁ and other disparate processors 110 (e.g., processor 110₂) associated with other disparate physically coupled computing nodes 106 (e.g., computing node 106₂). Hence, if processor 110₁ presently has a relatively high utilization, e.g. due to intensive updates to local region 108₁, while processor 110₂ is relatively idle, then synchronization component 202₁ can transfer portions of the load to other processors 110 that are associated with physically coupled computing nodes 106.

Additionally or alternatively, synchronization component 202 can facilitate various types of data operations 206. Data operations 206 can relate to data transfer between various memory stores 112 (e.g., between memory store 112₁ and 112₂) that are associated with physically coupled computing nodes 106 as well as other transactions with respect to data included in memory store 112. Likewise, synchronization component 202 can facilitate a transfer of data between private memory 118 and public memory 120 for a single computing node 106. In particular, as previously discussed, public memory 120 can be shared among other physically coupled computing nodes 106, however, upon decoupling, in some cases it can be desired that decoupled computing nodes 106 not have access to certain data.

In accordance therewith, synchronization component 202 can tag data propagated from private memory 120 with an identifier associated with the host computing node 106. Appreciably, both data propagated to a disparate memory store 112 of a disparate computing node 106 as well as data propagated to public memory 118 of the same memory store 112 can be tagged with the owner ID. In one or more aspects of the claimed subject matter, synchronization component 202 can delete data from an associated memory store 112 that is tagged with an owner ID associated with a physically decoupled computing node 106. Deletion of data can be applicable to a variety of applications and can be associated with user settings, licensing agreements, digital rights management (DRM) or the like.

For example, consider the case in which separable display 102 is employed for collaboration in connection with an open document. It might be necessary (or even desired) that a particular computing component 106 have access to the entire contents of the document, even though only a portion of the document might be rendered by a local region 108 associated with that computing component 106. Thus, when the instant computing component 106 is decoupled, all data associated with the open document can be maintained on both portions of what was previously the whole separable display 102. However, a user might not desire other information, say, personal information or information associated with other documents included in the desktop to be transferred to the decoupled computing node 106. In that case, synchronization component 202 can delete any such data from the decoupled computing node 106. Again, these settings can be configured by the user, or data can be transferred between public memory 118 and private memory 120 for a given computing node 106 based upon manipulation of objects presented by separable display 102.

For example, an icon representing access to a particular document can be moved/copied from one location on separable display 102 to local region 108₁. Thus, the contents of the document can be moved or replicated to memory store 112₁, potentially to private memory 120, and owner ID for that associated data can be updated to overwrite or jointly include an ID associated with computing node 106₁. Thus, when computing node 106₁ is detached, data pertaining to the document can be included with the detached portion, while remaining on or being removed from the other portion, depending upon settings. As another example, consider the case in which proprietary software (e.g., an application or operating system) is required for manipulating the document, yet only one copy is licensed, or the document includes copyrighted media for which only one copy is licensed. In those cases, access to stack information or protected content can be provided to all physically coupled nodes 106, since they can collectively operate as a single multi-node computing component 104, but when decoupled, certain licensing issues can arise. Thus, a public (e.g., view only) application can be provided to one of the separated entities, while the full licensed application can remain on the other entity. Similarly, protected content can remain on only one of the entities, while deleted from the other. In either case, the tag provided to certain data by synchronization component 202 can determine the actual results.

Referring now to FIG. 3, system 300 that illustrates various examples in association with facilitating data mobility in connection with a decomposable display is provided. System 300 can include separable display 102, which is illustrated as rendering various data elements on the anterior surface of separable display 102. In more detail, separable display 102 that can be configured as a UI for an associated computer-based device, as substantially detailed supra in connection with multi-node computing component 104. In addition to what has been discussed, it should be appreciated that separable display 102 can be distinguished from previous displays that function as a UI for conventional computing units for a number of reasons. First, separable display 102, although potentially existing in a state of a single, seamless display, can be physically divided, while typical display surfaces are visibly combined and/or only divisible in terms of software-based assignment of various panes or windows. Secondly, unlike many conventional displays, separable display 102 can be driven by a distributed, multiprocessor component, with the individual nodes of the multiprocessor component embedded in and distributed throughout separable display 102. Third, each node of the multiprocessor component can be responsible for UI transactions associated with a particular region of separable display 102. Accordingly, shared memory for the multiprocessor component can be arranged according to the geometry of the individual nodes. Hence, the claimed subject matter can provide unique data mobility or collaboration features.

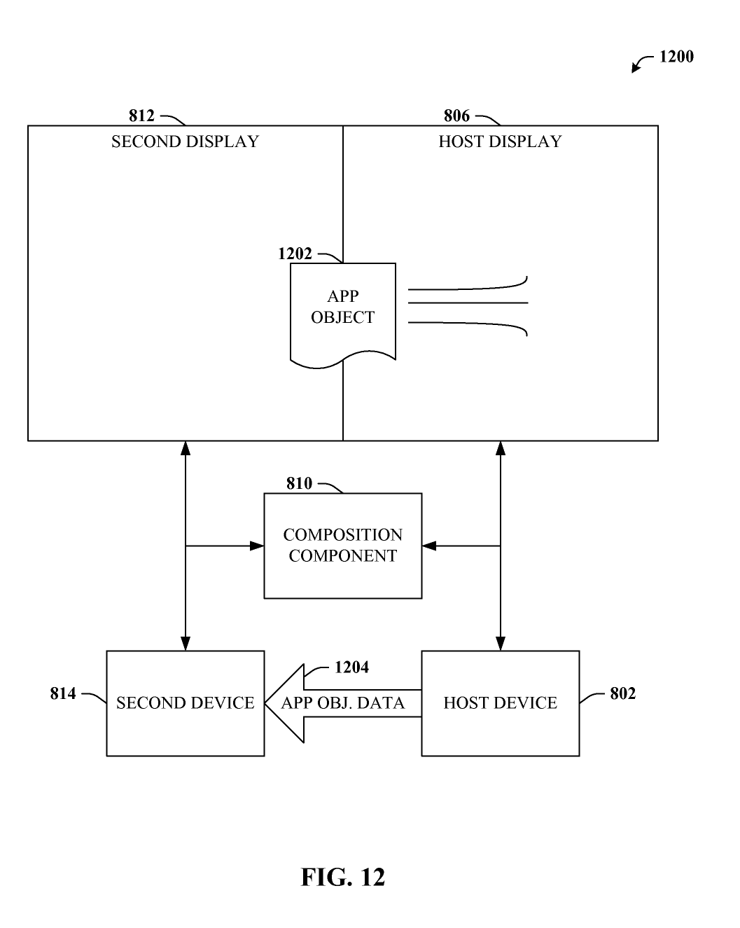

In the depicted aspect of the claimed subject matter, system 300 can include synch component 302 that can manage stored data for a memory store of an associated computing node of the computer-based device. In addition synch component 302 can facilitate data transfer between the memory store and a disparate memory store associated with a second computing node of the device. Appreciably, synch component 302 can be substantially similar to that which has been described in connection with synchronization component 202 of FIG. 2. Accordingly, in one or more aspects of the claimed subject matter, synch component 302 can manage memory for an associated memory store based upon UI transactions that occur in a region of separable display 102 managed by the host computing node. For example, data included in the region can be imported and stored locally to the associated memory store. Additionally or alternatively, synch component 302 can manage memory for an associated memory store based upon an object or data included in the region. For example, manipulating icons or other objects within separable display can result in data transfers between memory stores of various computing nodes, as substantially described supra in connection with FIG. 2, and as is further detailed infra in connection with FIG. 12.

Furthermore, system 300 can include geometry component 304 that can identify division boundaries 306 when a physical portion 310 of separable display 102 is decoupled from a remainder 312 of separable display 102. Physical separation can relate to tearing, dividing, severing, or otherwise uncoupling a portion of separable display 102, which can, but need not, be along previously structured or predefined division boundaries 306. In addition, system 300 can further include decomposition component 308 that can identify a first subset of computing nodes included in the portion 310. Decomposition component 308 can further identify a second set of computing nodes included in remainder 312, potentially based upon division boundaries 306. Appreciably, features of aspects of geometry component 304 and decomposition component 308 can be substantially similar to all or portions of polling component 114 discussed in connection with FIGS. 1 and 2.

The lower portion of FIG. 3 depicts various example representations of a presentation associated with separable display 102 for both remainder 312 and portion 310, after decomposition and/or decoupling. With respect to example remainder 312A, the remainder part can appear substantially identical to separable display 102, with division boundaries 306 included for reference. This outcome can be effectuated, e.g. in the case in which separable display 102 has multiple layers, all of which can be configured to operate as a UI. Thus, when one layer (e.g., the uppermost layer) is removed as portion 310, a lower layer can present the identical UI features. In that case, example portion 310 can be represented by either portion 310A or 310B. Portion 310A can be representative of the situation in which only data from those local regions associated with computing nodes of portion 310 is retained and presented. In contrast, portion 310B can be representative of the case in which all data originally available to separable display 102 for the rendering is maintained by portion 310, yet suitably resized to fit the dimensions of portion 310 or displayed in a different resolution.

Regarding example remainders 312B and 312C, the depicted representations can be illustrative of the case in which the remainder 312 is single-layered, such that the absence of portion 310 produces an associated gap in the available screen real estate relative to the original separable display 102. In the case of remainder 312B, data from local regions associated with portion 310 is no longer available, either due to settings, licensing or both. However, for example remainder 312C, the information that existed in portion 310 is still maintained by remainder 312C. This remaining data can be reformatted to suit the changed shape as depicted or, alternatively, can maintain the original structure, even if such would result in a change in size or resolution as is the case with portion 310B. In either case, whether 312B or 312C, the associated portion 310 can be described by portion 310A or portion 310B, depending upon what data is maintained by portion 310.

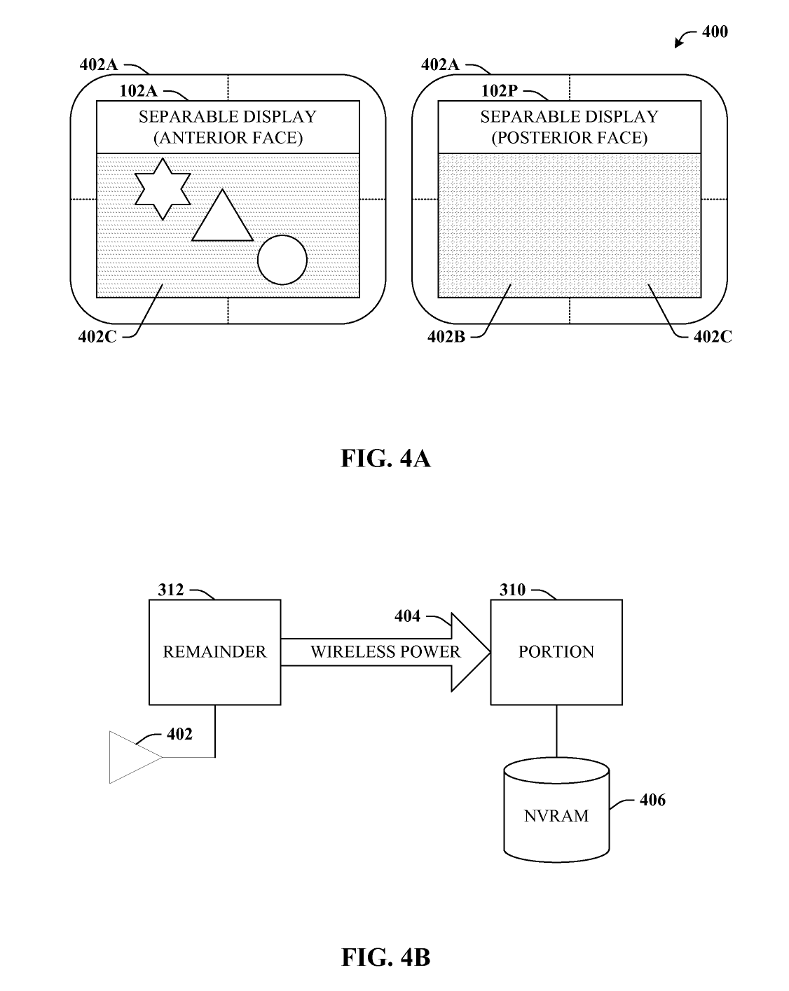

With reference now to FIGS. 4A and 4B, additional features or aspects relating to operable power sources and/or temporary powerless operation are illustrated. In one or more aspects of the claimed subject matter, and turning specifically to FIG. 4A, separable display 102 and/or an individual computing node (e.g., computing nodes 106) can further include power source 402, various examples of which are described by reference numerals 402A-402C. FIG. 4A illustrates at the left an anterior face 102A (e.g., front side) of the separable display, while at the right a posterior face 102P (e.g., the back side) is presented to further detail the various examples of power source 402.

As a first example, power source 402 can be a battery configured as a separable material strip 402A that constitutes lateral edges of separable display 102. In accordance therewith, the depicted bezel surrounding both representations of separable display 102A and 102P can be a battery. Thus, when separated, either along the depicted dotted lines or substantially any lateral edge of separable display 102, a section of power source 402A can be ported along with the decoupled portion, while another segment can remain with the remainder. Additionally or alternatively, power source 402 can be configured as separable material plate 402B coupled to posterior face 102P. In this case, since plate 402B can exist on posterior face 102P so as not to occlude the UI capabilities. Moreover, plate 402B can be mobile even for decoupled portions that do not include a lateral edge of separable display 102. As still another example, power source 402 can be separable photovoltaic film 402C that covers at least one of anterior face 102A or posterior face 102P. In the case of anterior face 102A, separable photovoltaic film 402C can be made of a substantially transparent material. A transparent material can be employed for photovoltaic film 402C that is utilized for posterior face 102P as well, yet would not tend to be necessary.

Furthermore, it should be understood that power source 402 can be constructed or fabricated by way of printing technologies or techniques. In particular, a battery that supplies power to components detailed herein can be printed directly upon or injected into a surface such as paper or a fabric, potentially with the use of special purpose equipment, “ink,” or other materials. In one or more aspects of the claimed subject matter, similar techniques or technologies can be employed to print all or a portion of separable display 102 (potentially including power source 402) onto a surface. The surface can be a special purpose fabric or paper or other material, and can be separable as well along pre-perforated boundaries or otherwise.

Referring specifically to FIG. 4B, it should be appreciated that irrespective of the actual source 402 of power, whether any of the above-mentioned or similar methods are employed, all or supplemental power can be provided to portion 310 wirelessly, as denoted by reference numeral 404. For example, separable display 102 can employ any or combinations of power sources 402A-402C as well as be coupled to conventional grids (e.g., plugged in to an electrical outlet). Thus, after decoupling, the same power sources 402 can be retained by remainder 312, while portion 310 can be powered by way of wireless power 404, which is further discussed in connection with FIG. 8. Additionally or alternatively, memory store 112 (particularly that for computing components 106 associated with portion 310) can be comprised of non-volatile random access memory (NVRAM) 406. Characteristically, NVRAM 406 retains state information even in the absence of power. Thus, when separated, even without an ample power source 402, portion 310 can continue to light up the associated local regions 108 of the display for a short time.

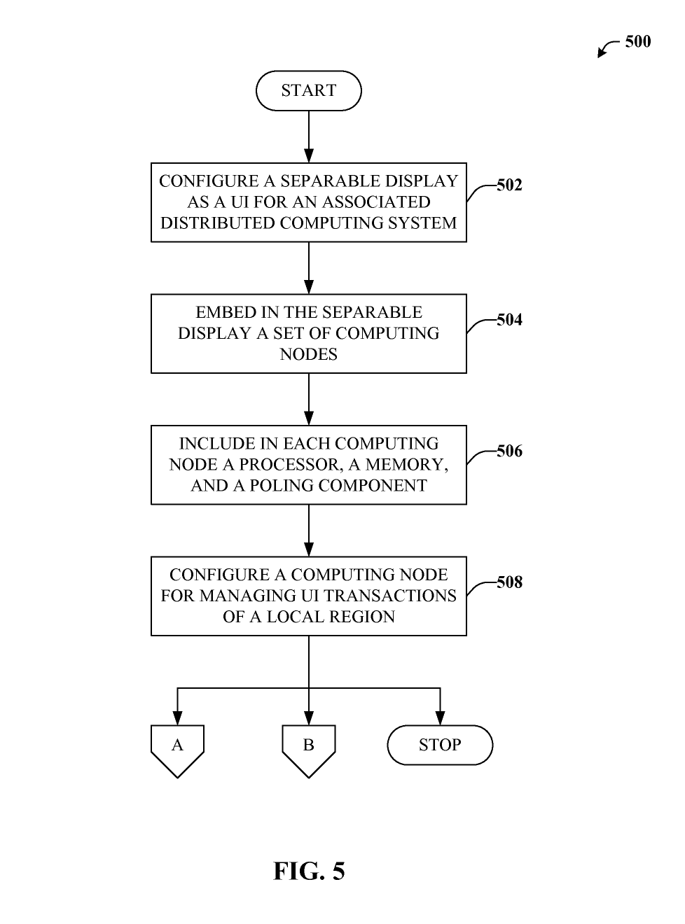

FIGS. 5, 6, and 7 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 5, exemplary computer implemented method 500 for providing a decomposable display illustrated. Generally, at reference numeral 502, a separable display can be configured as a UI for an associated distributed computing system. In other words, the separable display can represent an apparent unitary display for multiple computing units or nodes that comprise the distributed computing system. At reference numeral 504, a set of computing nodes that collectively constitutes the distributed computing system can be embedded in the separable display. The set of computing nodes can be embedded according to a somewhat random distribution or according to a predefined geometry or topology.

Moreover, at reference numeral 506, at least a minimum set of elements necessary to operate as an autonomous computing unit as well as operate in unison with other computing units can be included in each computing node. In particular, at least a processor, a memory, and a polling component can be included in each computing node. The polling component can be configured for identifying other computing nodes physically attached (e.g., nodes that are embedded in a connected portion of the separable display) to the separable display to which the host computing node for that particular polling component is attached. In addition, at reference numeral 508, a computing node in the set of computing nodes can be configured for managing UI transactions and/or I/O transactions in connection with a local region of the separable display that is proximal to the computing node. For instance, the location within the separable display at which a given computing node is embedded, as well as a surrounding area, can be managed, potentially exclusively, by that computing node.

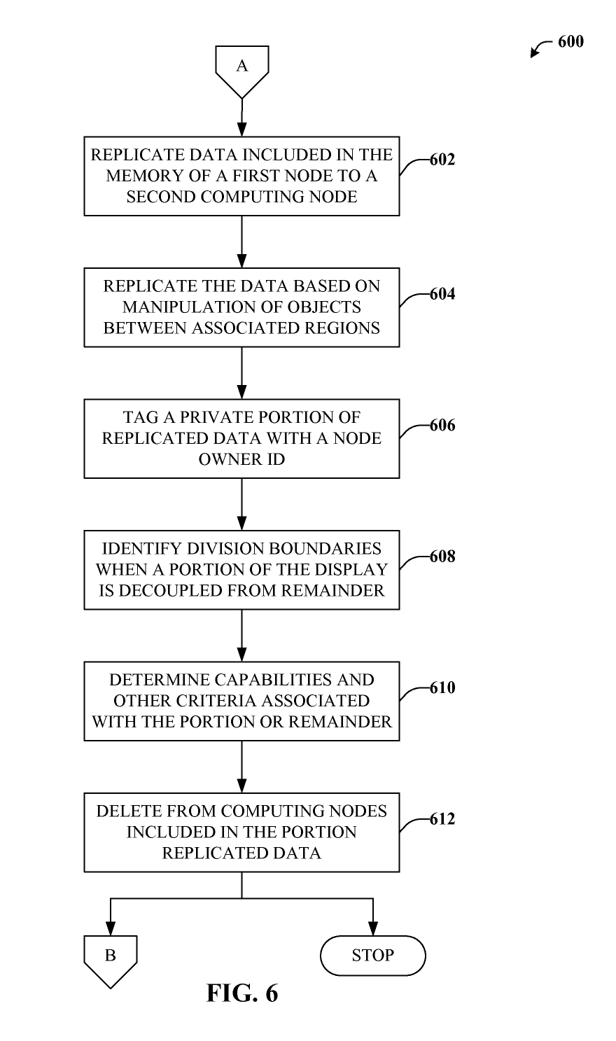

Turning now to FIG. 6, exemplary computer implemented method 600 for facilitating data mobility or collaboration in connection with a decomposable display is depicted. Initially, at reference numeral 602, data included in the memory of a first computing node can be replicated (or moved) to the memory of a second computing node for enabling the second computing node to autonomously manage an associated second region of the separable display in the event of a decoupling of the first computing node and the second computing node. In other words, should the current duties or predicted future duties in light of a decoupling of the second computing node require access to data that is not stored in the second computing node's associated memory, then such memory can be obtained from the first computing node's associated memory, which will typically be unavailable should the first and second computing nodes by decoupled.

Furthermore, at reference numeral 604, the data obtained in connection with reference numeral 602 can be obtained based upon manipulating of objects between a first region of the separable display associated with (e.g., managed by) the first computing node and the second region that is managed by the second computing node. Moreover, at reference numeral 606 a private portion of any data replicated at reference numerals 602 or 604 can be tagged with a node owner ID. Accordingly, data ownership, or licensing or privacy issues can be mitigated in connection with the node owner ID tag as explained below.

In particular, at reference numeral 608, division boundaries can be identified when a physical portion of the separable display is decoupled from a remainder of the separable display. In addition, at reference numeral 610, a set of capabilities of, a set of data available to, a physical location of, or a region of the separable display managed by computing nodes included in the portion and/or the remainder can be determined. Thus, any given computing node can be appraised of all physically coupled neighbors and their associated capabilities and geometry, as well as those that are no longer coupled and the associated space and capabilities that are therefore no longer available. Moreover, with respect to data tagged in connection with reference numeral 606, at reference numeral 612, replicated data tagged with a node owner ID associated with a computing node included in the remainder can be deleted from computing nodes included in the portion.

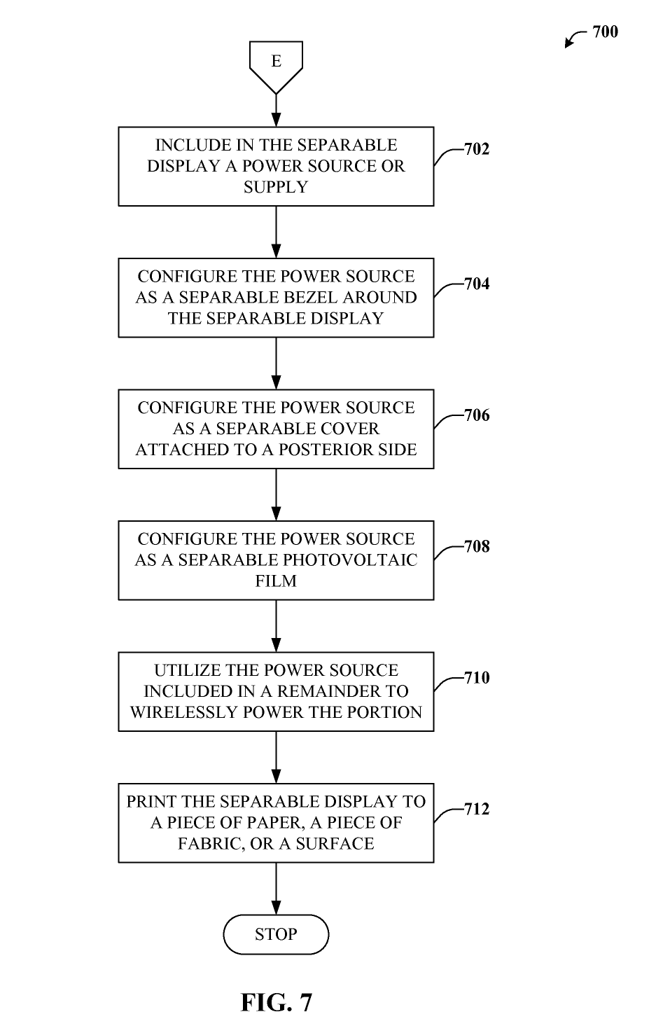

Referring to FIG. 7, exemplary computer implemented method 700 for structuring a power supply for the separable display or portions thereof is provided. In general, at reference numeral 702, a power source configured to supply power to the separable display and to the embedded set of computing nodes that constitute the distributed computing system can be included in the separable display. As one example power source, at reference numeral 704, the power source can be configured as a separable material (e.g. a battery or charge store) bezel around the separable display. Thus, when any portion of the separable display is removed from a remaining portion, as long as both portions include some segment of a lateral edge of the original separable display, then both portions can have a ready source of power by way of the battery bezel.

As another example, at reference numeral 706, the power source can be configured as a separable material cover attached to a posterior side of the separable display. In this case, substantially any portion of the display can be powered even when separated from other portions. In one or more aspects of the claimed subject matter, the power source can be configured as a separable photovoltaic film that coats the posterior side or an anterior side of the separable display, with is detailed in connection with reference numeral 708. Accordingly, ambient light can provide power for any portion of the separable display, which can be produced as a transparent film so as not to obscure or occlude information presented on the anterior face. As another example, at reference numeral 710, the power source included in a remainder of the separable display can be utilized to wirelessly power a decoupled portion of the separable display. Additional features relating to wireless power or energy transmission are discussed in connection with FIG. 8, infra. Last to be described, at reference numeral 712, the separable display or a portion of the separable display can be printed to a suitable surface. For example, the separable display can be printed to a piece of paper or a piece of fabric. Special purpose printers and “ink” can be employed for applying the separable display to the surface.

### Composable Surfaces

Referring now to FIG. 8, computer-implemented system 800 that can facilitate dynamic composition of multiple disparate display surfaces is depicted. Generally, system 800 can include host device 802, which can be substantially any type of computer or computing device. Accordingly, it should be appreciated that host device 802 can be separable display 102 or portion 310 or remainder 312, as discussed in the previous section. Regardless, host device 802 can include a processor that executes instructions associated with application 804, which can be substantially any type of computer-based application. In addition, system 800 can further include host display 806 that can be operatively coupled to host device 802.

For example, host display 806 can be attached to host device 802, connected in a wired fashion, or connected wirelessly. Host display 806 can operate as a UI for application 804 that is executed by host device 802, and can thus display visible features of application UI 808. Appreciably, host display 806 can be a touch-screen or other tactile-based display sensitive to contact or gestures, or substantially any type of display surface. Moreover, host display 806 can include or be operatively coupled to other I/O components (e.g., speakers, microphone, keyboard or keypad, network connection . . . ). Hence, host display 806 can present or expose additional features of application UI 808 beyond visual output, such as sound or acoustic aspects of UI 808, connectivity features or apps, as well as interactivity by way of various inputs.

In addition, system 800 can include composition component 810 that can detect second display 812. Similar to host display 806, second display 812 can be substantially any type of display surface, can include additional I/O features or capabilities, and can be operatively coupled to second device 814, for which second display 812 can serve as an UI component for second device 814. Thus, both host display 806 and second display 812 can represent, inter alia, independent display surfaces for associated computing devices (e.g., host device 802 and second device 814, respectively). In many cases, typical computing devices such as laptop computers, tablets, cellular phones, smart phones, digital cameras, media players or recorders, televisions and so forth include a display of some form factor as a single, composite unit. In other cases, as with personal or desktop computers, gaming consoles or the like, the associated display (e.g. a monitor or television) can be a disparate device. In still other cases, as known in the art of surface computing, specialized surfaces, often with a specialized UI that leverages intuitive, hands-on manipulation of objects can represent one or both host display 806 or second display 812. Appreciably, as with host display 806, second display 812 can be all or a portion of separable display 102 such as, e.g., portion 310 or remainder 312.

In the domain of surface computing, the associated displays are generally touch-sensitive screens of substantially any form factor that often forego many traditional I/O devices such as a keyboard or mouse in favor of tactile-based manipulation. However, such I/O devices, if available and/or preferred can of course be employed. In accordance therewith, many ordinary surfaces of today such as tabletops, desks, walls, kiosks, billboards, and so forth can be envisioned to be replaced by interactive surface-based computing displays. Moreover, in addition to large hardware, suitable display surfaces can be developed to be or to simulate paper or fabric. Thus, a paper-like surface that can be folded and placed in one's pocket (or a handkerchief or a fabric worn as apparel) can operate as a display surface or UI for a computer-based application. Such surfaces can themselves be an independent computing unit, with processing features, memory, communication apparatuses, and a power source, or be reliant to some degree on an associated computing device.

For example, advances in miniaturization have enabled such displays to include suitable processors, memory, and communication devices, however, power sources remain today relatively bulky and insufficient for many purposes. Thus, in accordance with one or more aspects of the subject claims, the power source for a given display can be migrated to an associated device. In particular, host display 806 or second display 812 can be powered by an associated device (e.g. host device 802 or second device 814) by way of wireless power transmission and/or wireless energy transfer. Such implementations can include but are not limited to near field techniques such as induction or resonant induction, as well as far field techniques such as radio, microwave, or laser “beaming.” As discussed herein, near field techniques will typically be most suitable. For instance, resonant induction can achieve 75% efficiency at a distance of 80 centimeters or less. In addition, to provide more flexibility or to conserve power, processing or memory can also be farmed out to the associated device, whereby data is exchanged by well-known wireless communication techniques.

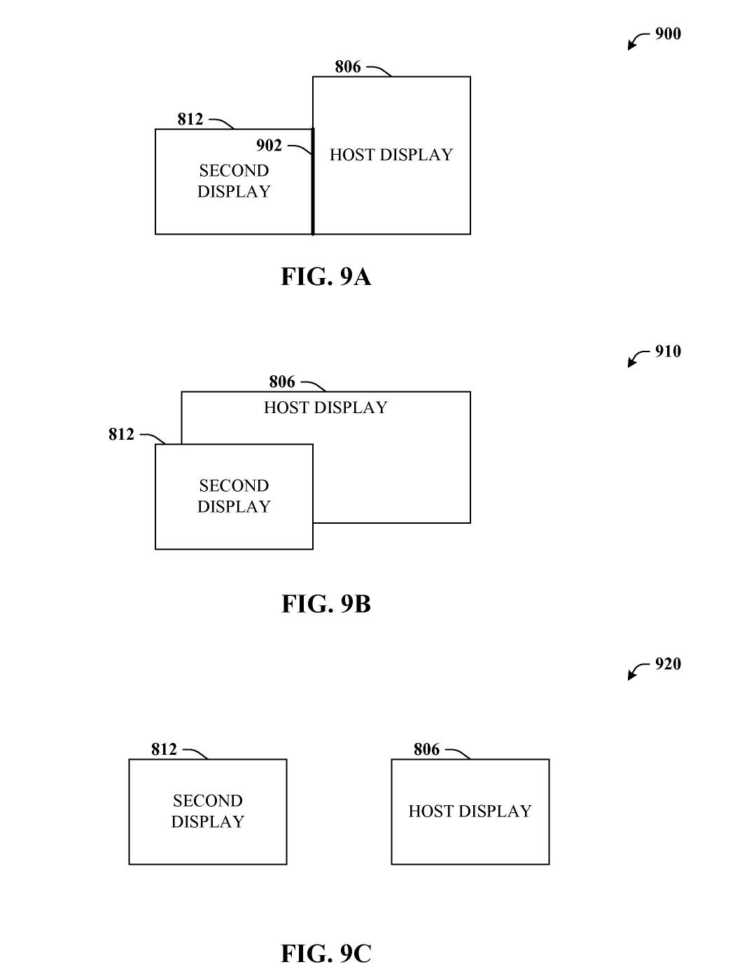

It should be understood that host display 806 and second display 812 can be a display from any of the above-mentioned classes of displays or other suitable displays. However, in many instances, the claimed subject matter can relate particularly to the domain of surface computing. Moreover, host display 806 (and second display 812) can include all or a portion of the features normally associated with host device 802 (e.g. processing, memory, power source), or such features can be remote as expressly depicted. Regardless of the particular implementation, composition component 810 can extend application UI 808 to second device 812 based upon a determined display surface geometry, which is further discussed in connection with FIGS. 9A-9C, infra.

While still referring to FIG. 8, but turning simultaneously to FIGS. 9A-9C, various exemplary surface topologies are depicted. In particular, FIG. 9A provides diagram 900, illustrating an example of adjacent displays, FIG. 9B provides diagram 910, illustrating an example of overlapping displays, and FIG. 9C provides diagram 920, illustrating an example of proximal displays. Diagrams 900, 910, and 920, will be referred to in subsequent portions of the description to provide ready conceptual examples. As indicated above, composition component 810 can extend UI 808 for application 804 to second display 812 based in part upon a determined display surface geometry.

The display surface geometry can include a shape of second display 812, a size of second display 812, either absolute or relative to the host display 806, a location of second display 812 relative to host display 806, an orientation of second display 812 relative to host display 806 or the like. As one example, second display 812 can be an adjacent display that shares mutual border 902 with host display 806. Thus, when two or more displays make contact along the boundaries of respective display surfaces, the displays can be characterized as adjacent displays exemplified by diagram 900. In another example, second display 812 can be an overlapping display that overlays all or a portion of host display 806, which is depicted by diagram 910. In contrast, diagram 920 illustrates a situation in which physical contact between the multiple displays does not occur. Rather, second display 812 is a proximal display that is in close proximity to host display 806.

Still referring to FIG. 8, it should be appreciated that a variety of techniques or technologies can be employed by composition component 810 (or other components referenced herein) in order to facilitate or accomplish the claimed subject matter. For example, composition component 810 can employ UPnP 816 in order to detect and/or identify second display 812. UPnP 816 can support zero-configuration networking, wherein substantially any device can dynamically join a network or communication session. Such devices can obtain or allocate addresses, broadcast or assign device names, discover or announce presence, as well as convey, request, or receive device capabilities. Additionally or alternatively, composition component 810 can employ techniques relating to well-known server clustering 818, e.g., to construct and maintain membership to the cluster.

Of course, UPnP 816 and server clustering 818 are merely exemplary technologies that can be employed in connection with the claimed subject matter. Appreciably, other techniques or technologies are envisioned or can be suitable as well. Regardless of how the network or cluster is established between host display 806 (and/or host device 802) and second display 812 (and/or second device 814) as well as additional members, each member can be detected or discovered based upon aspects of proximity. For example, Near Field Communication (NFC), which is inherently low power and short range, can be employed for initial discovery and/or introduction or handshaking. As one example, a NFC packet can carry UPnP 816 discovery algorithm. However, higher bandwidth protocols such as Wi-Fi (IEEE 802.11x specifications) or Bluetooth (IEEE 802.15.x specifications) can be subsequently employed for actual application-based data exchange. Additionally or alternatively, techniques associated with physical contact or line of sight can be employed for proximity-based detection by or for composition component 810.

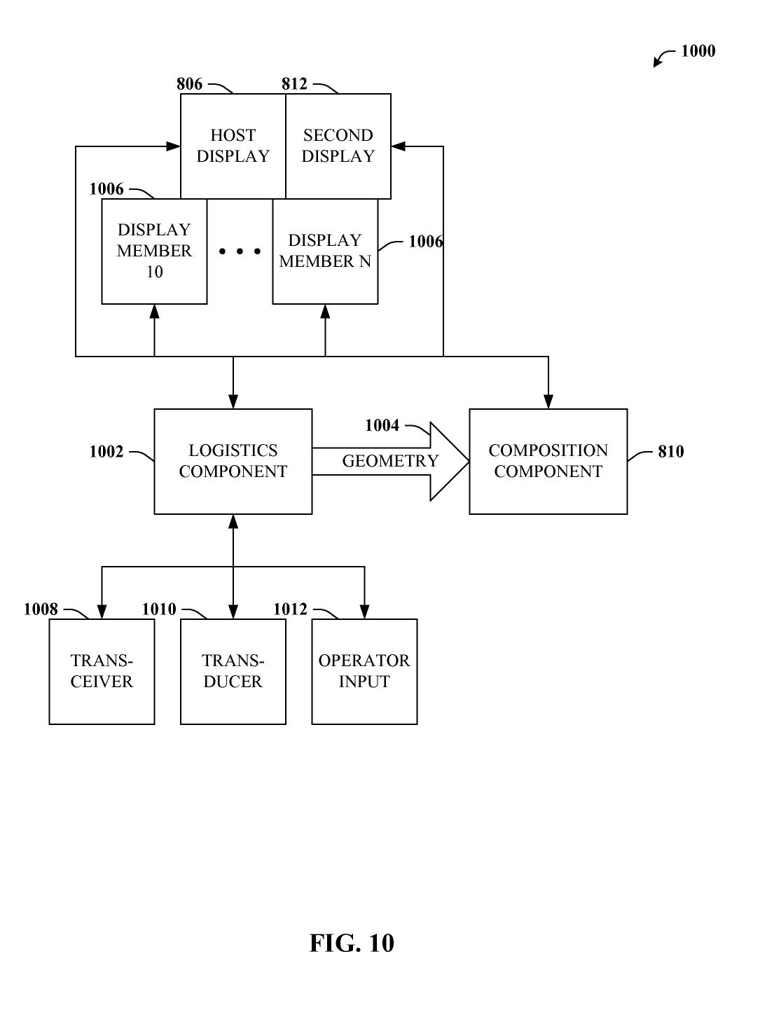

Next, once one or more disparate displays (e.g. second display 812) are detected, composition component 810 can extend application UI 808 to the disparate displays based upon a determined display surface geometry. Regardless of the techniques or technologies employed (e.g., 816, 818), additional detail relating to determining display surface geometry is provided in connection with FIG. 10, whereas FIG. 11 and associated text relates to maintaining device capability lists. FIG. 12 relates to migration of data based upon associated UI object transitions. Following the detailed description of these figures, a number of example use scenarios are provided to aid in conceptual grasp of the claimed subject matter.

Turning now to FIG. 10, system 1000 that can determine display surface geometry in a variety of ways is illustrated. In general, system 1000 can include composition component 810 as substantially described above. In addition, system 1000 can include logistics component 1002 that can be included in or operative coupled to composition component 810. For example, consider multiple display devices including host display 806, second display 812, and any number, M, additional member displays (referenced either collectively or individually as member displays 1006) that are shown here for illustrative purposes as adjacent display (e.g. diagram 900 of FIG. 9A).

Logistics component 1002 can provide display surface geometry 1004 to composition component 810 by way of a wide range of techniques or technologies, such as transceivers 1008, transducers 1010, or even operator input 8012. For instance, logistics component can automatically determine display surface geometry 1004 based upon a set of transceivers 1008. Such transceivers 1008 can operate in connection with electromagnetic radiation (e.g., light) and can employ techniques associated with trilateration, triangulation, or multipath propagation in order to ascertain the positions of each display relative to others. Likewise, the same techniques can be employed in connection with transducers that are sensitive to acoustic vibration (e.g., sound) in order to ascertain the positions of each display. For example, vibrations that result from physical contact between the displays can be employed to ascertain relative positions. Additionally or alternatively, displays adequately equipped can broadcast an acoustic beacon (e.g., by way of ultrasound or the like) with a particular signature that when received by host display 806 at disparate receivers can be employed to identify the location of the beacon source relative to host display 806. With the position on second display 812 of the acoustic emitter precisely defined, the exact display surface geometry can be ascertained. The above-mentioned techniques can be employed in connection with various topologies exemplified by diagrams 900, 910, or 920.

As another example, a set of tactile-based or piezoelectric transducers (e.g., transducers 1010) can be employed to identify when contact is made between displays as well as the scope or boundaries of such contact. For instance, some or all of the displays can be equipped with a thin magnetic or piezoelectric strip around the edges or other areas of the display, which can sense when and where contact is made. Generally, these techniques can be applicable to adjacent displays exemplified by diagram 900, but can also in some cases be utilized in connection with overlapping displays illustrated by diagram 910.

In one or more aspects of the claimed subject matter, a set of Hall Effect transducers 1010 can be employed to identify features of a magnetic field associated with second display 812. For instance, proximity and position of the second display 812 can be determined based upon a resident magnetic field surrounding the display. Hall effect transducers can be most pertinent to overlapping displays detailed in connection with diagram 910, but can also be employed for adjacent displays such as those exemplified by diagram 900. Another example set of transducers 1010 that can be utilized for overlapping displays can be a set of photodetectors. For example, a thin, transparent layer of photodetectors can exist in host display 806 (or other displays). Thus, based upon a change in the light density of portions overlaid by overlapping displays, display surface geometry 1004 can be determined.

In one or more aspects, logistics component 1002 can determine display surface geometry 1004 based upon operator input 1012. For example, operator input 1012 can relate to a gesture indicative of display surface geometry, such as a gesture that traces the boundaries of overlapping displays or the mutual border(s) for adjacent displays. As another example, operator input 1012 can be a substantially straight line or another shape or mark that spans portions of both host display 806 and second display 812. From such input, the relative topology can be determined as the line spans coordinates that are known to be adjacent between disparate displays. In another aspect, operator input can be explicit coordinate input of substantially any suitable variety. Appreciably, the above examples are intended to provide concrete illustrations, but are not necessarily intended to limit the scope of all appended claims. Rather, other types of sensors, operator input, or means of determining display surface geometry 1004 can also be suitable in connection with the claimed subject matter.

Referring now to FIG. 11, system 1100 that can maintain a set of capabilities for all connected devices is provided. System 1100 can include composition component 810 that can detect displays in physical proximity and extend a UI to those detected displays. Furthermore, system 1100 can include facility component 1102 that is operatively coupled to or included in composition component 810. Facility component 1102 can enumerate capabilities of host device 802 in order to populate host capabilities list 1104, which can be provided to second device 814 as well as other member devices 1106, where each member device 1106 is related to an associated display member 1006 that is adjacent, overlapping, or proximal to host display 806.

The capabilities enumerated by facility component 1102 can include a set of I/O devices or sensors such as, e.g. keys, a mouse, speakers, microphones, biometric devices, cameras and so on. The capabilities can also include network capabilities (e.g., Wi-Fi, Bluetooth, cellular . . . ), or relevant dimensions or device specifications (e.g., size or shape of associated display, screen resolution or colors, as well as location of relevant features such as speakers/emitters). A substantially similar list enumerating capabilities 1108 of member devices (e.g. 814, 1106) can be constructed or received by facility component 1102 as well.

Furthermore, facility component 1102 can transmit host capabilities list 1104 and member capabilities list 1110 to second device 814 as well as to other member devices 1106. These lists 1104 and 1110 can be combined into a single list or transmitted separately. Moreover, facility component 1102 can leverage UPnP in order to effectuate discovery of the capabilities of all connected devices as discussed supra. Regardless, it should be readily appreciated that an ongoing combined capabilities list or table can be maintained in real time, with capabilities added or removed as member devices join or disconnect. In addition, based upon the available capabilities, composition component 810, in one or more aspects of the claimed subject matter, can expose additional features of application 804, e.g., when certain capabilities are annexed from member devices (e.g., devices 814 or 1106).

Turning now to FIG. 12, system 1200 that can facilitate transition of objects and related data between displays and associated devices is depicted. Depicted in FIG. 12 are again second display 812, which can be viewed as either adjacent to host display 806 or overlapping half the display surface of host display 806. However, it should be appreciated that the concepts described can apply equally to geometries that do not involve contact such as that described in connection with diagram 920 of FIG. 9C. As with previous figures, system 1200 can include composition component 810 as substantially described supra. In addition, composition component 810 can facilitate seamless visual transition of application object 1202 between host display 806 and second display 812 (or another member display 1006). As one example, application object can be icon representative of a document. An operator interacting with a surface of host display 806 can slide the document toward second display, and as the visual presentation of the moving app object reaches the boundaries of second display 812 (or, depending on the geometry, leaves the boundaries of host display 806), application UI 808 that has been extended to second display 812 seamlessly renders object 1202 maintaining the trajectory.

Given application object 1202 is now in the process of being presented on second display 812, composition component 810 can facilitate storage of application object data 1204 to second device 814 upon transition from host display 806 to second display 812. Likewise, in the case where application object 1202 is moved from second display 812 to host display 806, composition component can facilitate storage of data 1204 related to application object to host device 802. Typically, upon such transitions, associated data 1204 can be duplicated, however, it should be understood that in some cases, data 1204 can be moved without duplication. Appreciably, what is described herein can facilitate a wide range of use scenarios, many of which can now be described.

### Example Use Scenarios

For instance, since displays (as well as associated devices) can connect or disconnect in an ad hoc or capricious fashion, potentially at the whim of an operator, the claimed subject matter can provide a natural or intuitive way of understanding and/or tracking data access or flow. Such features are readily appreciated when moving application object 1202 from one display to another, with an inherent understanding that associated data 1204 is now accessible to second device 814, and can (but need not) persist on the second device 814 when or if second display 812 is disconnected or undocked. In some cases, an operator of second device 814 can manipulate object data 1204 (e.g., make changes to a document), then send application object 1202 back to host display 806. Since application object 1202 originated from host display 806, the transition in this case can invoke a move operation rather than a copy operation.

Drawing once more from the domain of surface computing, consider an interactive home or office desktop, where the conventional PC is not a series of boxy artifacts existing on the desk, but rather integrated therein. All or portions of the interactive surface can be overlaid by composable surfaces, such that in the base state many modular displays akin to paper-like sheets or tablets overlay the desk. While the desk itself is an interactive surface, each display can seamlessly overlay a portion of the desk, and present an identical UI. Thus, when interacting with a document, the document can be moved to the area of the desk that is occupied by an overlaying sheet or other display. Then the sheet can be separated from the desk, and the document can remain visible on the detached display (and potentially remain on the lower layer as well, either on the desk surface or another intervening display). In this scenario, an operator can now lean back in her chair or otherwise assume a more comfortable position while working with the document. Moreover, the operator can carry the detached display to another desk or suitable device and share the document, potentially allowing a collaborative session with respect to the document.

In another aspect, public surfaces, e.g. a kiosk, can be available that allow various types of interaction, such as browsing a store catalog or current sales, viewing maps or points of interest, obtaining information about various sites or monuments, etc. A user with, say, a smart phone can bring the smart phone in close proximity to the billboard, then move objects from the kiosk to the phone, for instance, advertisements for products, maps, media guides and so forth. Appreciably, these and other features can be accomplished without installing special software. Rather, UPnP can be employed or other types of connectivity handshaking or introductions such as sending an email or Short Message Service (SMS) message to an address displayed by the surface, and then receiving information in return for establishing a connection; or employing the phone to take a picture of a barcode or address displayed by the surface to facilitate a connection. Additionally or alternatively, once a connection is established, features of the phone, e.g. a keyboard or network connection as well as resident information, can be utilized in connection with the application running on the host surface.

As still another example, a collection of users can physically bring together multiple displays from, say, a tablet PC, a couple cellular phones, and several laptop computers. These collections of multiple displays can not only provide a larger use space or surface, but can also be readily conducive to collaborative endeavors. Moreover, given the composition of multiple devices, capabilities of one device can be shared. For example, consider an application that requires a fingerprint scan for authorization or authentication. However, the party to be authorized is utilizing one of the cellular phones that is not equipped with any biometric devices. Fortunately, one of the connected laptop computers does have an attached fingerprint scanner that can be employed.

Now turning to FIG. 13, system 1300 that can perform or aid with various determinations or inferences is illustrated. Generally, system 1300 can include synch component 202, composition component 810, logistics component 1002, and facility component 1102 as substantially described herein, as well as any other suitable components. In addition to what has been described, the above-mentioned components can make intelligent determinations or inferences. For example, synch component 202 can employ intelligent determinations or inferences with managing load balancing of processor utilization, or when replicating or duplicating data sets, as well as tagging the data with node owner IDs. Also, composition component 810 (or in some cases logistics component 1002) can intelligently distinguish between displays that intentionally approach host display 806 and those that approach due to happenstance. Such inferences can be based upon, e.g., a trajectory or an orientation of the approaching device, as well as other indicia. In addition, composition component 810 can intelligently interface to second device 814 in order to extend, commandeer, update, or instruct as to application UI 808. In some cases, composition component 810 can intelligently select suitable techniques, protocols, or technologies (e.g., UPnP, server clustering . . . ) by which to interface to disparate displays or devices as well as managing data access when data is transferred from one device to another, e.g., distinguishing between copying versus moving.

Additionally, logistics component 1002 can intelligently determine display surface geometry 1004 based upon suitable approximations as well as a variety of potential parameters that might not always agree or align. Furthermore, facility component 1102 can make intelligent determination or inferences with respect to enumerating capabilities. For example, in some cases or circumstance, certain features might not be available or sharable, in which case, the associated features can (but need not) be ignored or dropped from a capabilities list. Appreciably, any of the foregoing intelligent determinations or inferences can potentially be based upon, e.g., Bayesian probabilities or confidence measures or based upon machine learning techniques related to historical analysis, feedback, and/or other determinations or inferences.

In addition, system 1300 can also include intelligence component 1302 that can provide for or aid in various inferences or determinations. In particular, in accordance with or in addition to what has been described supra with respect to intelligent determinations or inferences provided by various components described herein. For example, all or portions of composition component 810, logistics component 1002, and facility component 1102 can be operatively coupled to intelligence component 1302. Additionally or alternatively, all or portions of intelligence component 1302 can be included in one or more components described herein.

Moreover, intelligence component 1302 will typically have access to all or portions of data sets described herein, such as data store 1304. Data store 1304 is intended to be a repository of all or portions of data, data sets, or information described herein or otherwise suitable for use with the claimed subject. Data store 1304 can be centralized, either remotely or locally cached, or distributed, potentially across multiple devices and/or schemas. Furthermore, data store 1304 can be embodied as substantially any type of memory, including but not limited to volatile or non-volatile, sequential access, structured access, or random access and so on. It should be understood that all or portions of data store 1304 can be included in system 800, or can reside in part or entirely remotely from system 800.

Accordingly, in order to provide for or aid in the numerous inferences described herein, intelligence component 1302 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

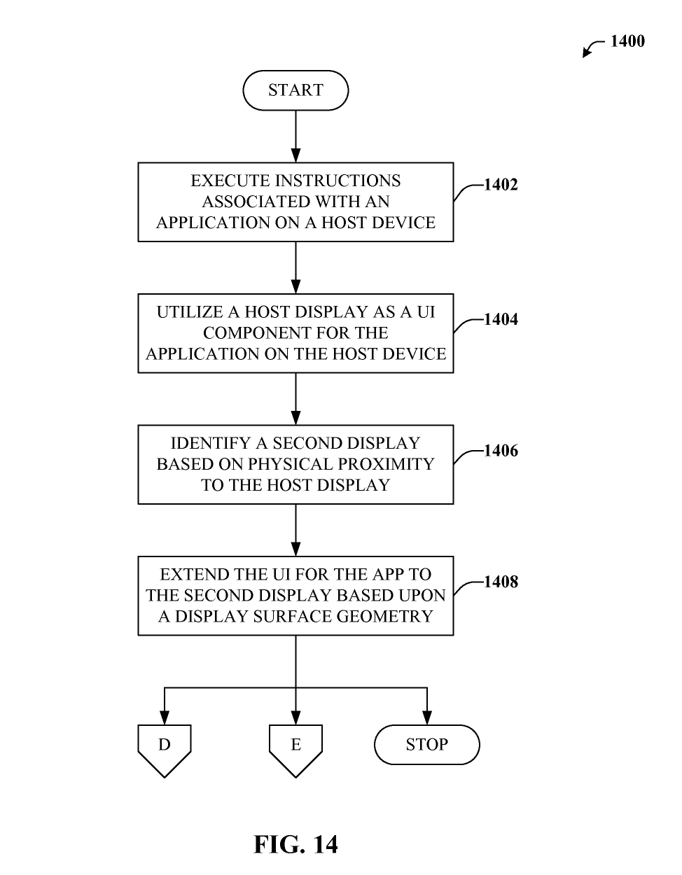

FIGS. 14, 15, and 16 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 14, exemplary computer implemented method 1400 for facilitating dynamic composition of multiple disparate display surfaces is illustrated. Generally, at reference numeral 1402, instructions associated with an application can be executed on a host device. The application can be substantially any computer-based application, ranging from, e.g. a desktop application to a document viewer/editor.

Moreover, at reference numeral 1404, a host display that is operatively coupled to the host device can be utilized as a UI component for the application. In other words, the host display constitutes at least one portion of a UI adapted to present or interact with the application. For example, the host display can present visualizations associated with application and receive tactile-based inputs such as touch or gestures. Appreciably, other UI components (e.g., speakers, microphone, keys/buttons . . . ) can exist as well, either distinct from or embedded in the host display.

At reference numeral 1406, a second display can be identified based at least in part on physical proximity to the host display, wherein the second display operates as a UI component for a disparate second device. At reference numeral 1408, the UI for the application can be extended to the second display based upon a determined display geometry. The determined display geometry can be employed for understanding where the boundaries of the second display reside, especially relative to the host display.

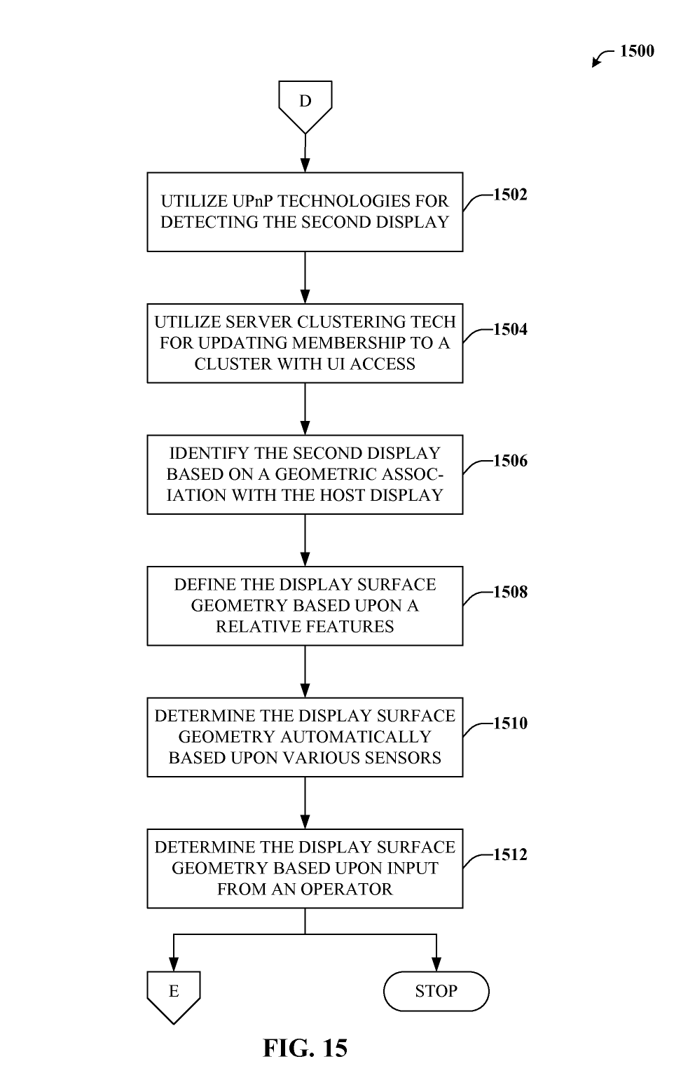

Referring to FIG. 15, exemplary computer implemented method 1500 for providing additional features in connection with dynamic composition of multiple disparate display surfaces is depicted. At reference numeral 1502, UPnP technologies can be utilized for detecting the second display. Additionally or alternatively, at reference numeral 1504, server clustering technologies can be utilized for creating, maintaining, or terminating membership to a cluster, wherein membership can be defined as having access to the UI for the application. Appreciably, UPnP can support zero-configuration networking, wherein substantially any device can dynamically join a network or communication session. Such devices can obtain or allocate addresses, broadcast or provide device names, discover or announce presence, as well as convey, request, or receive device capabilities.

Next to be described, at reference numeral 1506, the second display identified at reference numeral 1406 of FIG. 14, can be identified as at least one of an adjacent display that abuts the host display along a mutual border; an overlapping display that covers all or a portion of the host display, potentially including additional surface area as well; or a proximal display that is near to the host display. Beyond identifying and/or classifying the second display, at reference numeral 1508, the display surface geometry can be defined based upon a relative size, shape, location, or orientation of the second display, potentially with respect to the host display, while in other cases, portions of these data can be provided in absolute terms.

At reference numeral 1510, the display surface geometry can be determined automatically based upon at least one of a set of transceivers, a set of transducers, other suitable sensors or devices, or combinations thereof. Thus, in addition to dimension or other size or shape data that can be provided during initial communications, relative positions can be automatically determined, potentially based upon characteristics of light or acoustics, as detailed in several examples supra. At reference numeral 1512, the display surface geometry can be determined based upon input from an operator. Such input can include boundary tracing gestures, indicia (e.g., lines or shapes) that spans portions of both the host display and the second display, or coordinate parameters of substantially any type of variety.

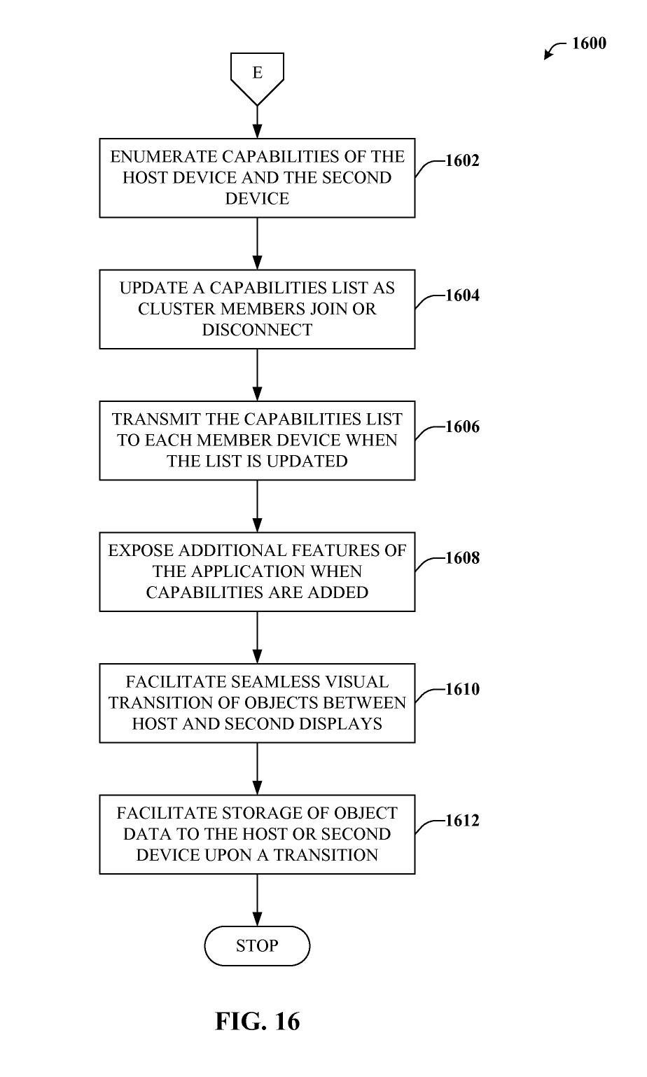

With reference now to FIG. 16, method 1600 for providing additional aspects or feature associated with capabilities and transitions is provided. Generally, at reference numeral 1602, capabilities of the host device and the second device can be enumerated. Suitable enumerated capabilities can include, e.g. a set of I/O devices or sensors such as, e.g. keys, a mouse, speakers, microphones, biometric devices, cameras and so on. The enumerated capabilities can also include network capabilities (e.g., Wi-Fi, Bluetooth, cellular . . . ), or relevant dimensions or device specifications (e.g., size or shape of associated display, screen resolution or colors, as well as location of relevant features such as speakers/emitters).

Accordingly, at reference numeral 1604, one or more capabilities lists can be updated as members connect or disconnect. Appreciably, the combined list or lists can be kept current in real time on the host device. Moreover, at reference numeral 1606, the capabilities list(s) can be transmitted to each member device when capabilities the list(s) are updated, typically due to member connection or disconnection. Thus, the capabilities of the combined devices can be kept current on member devices as well as the host device.

Based upon the above-mentioned data, at reference numeral 1608, additional features of the application can be exposed when capabilities are added from member devices. For example, newly added I/O components, network capabilities, or the like can be employed to operate on substantially any portion of the combined UI. Likewise, at reference numeral 1610, seamless visual transition of application objects can be facilitated between the host display and the second display. Moreover, at reference numeral 1612, storage of data associated with the application object, either through duplication or moving transactions, can be facilitated. In particular, upon a transition of the application object between the host display and the second display, associated data can be stored to the host device or the second device.

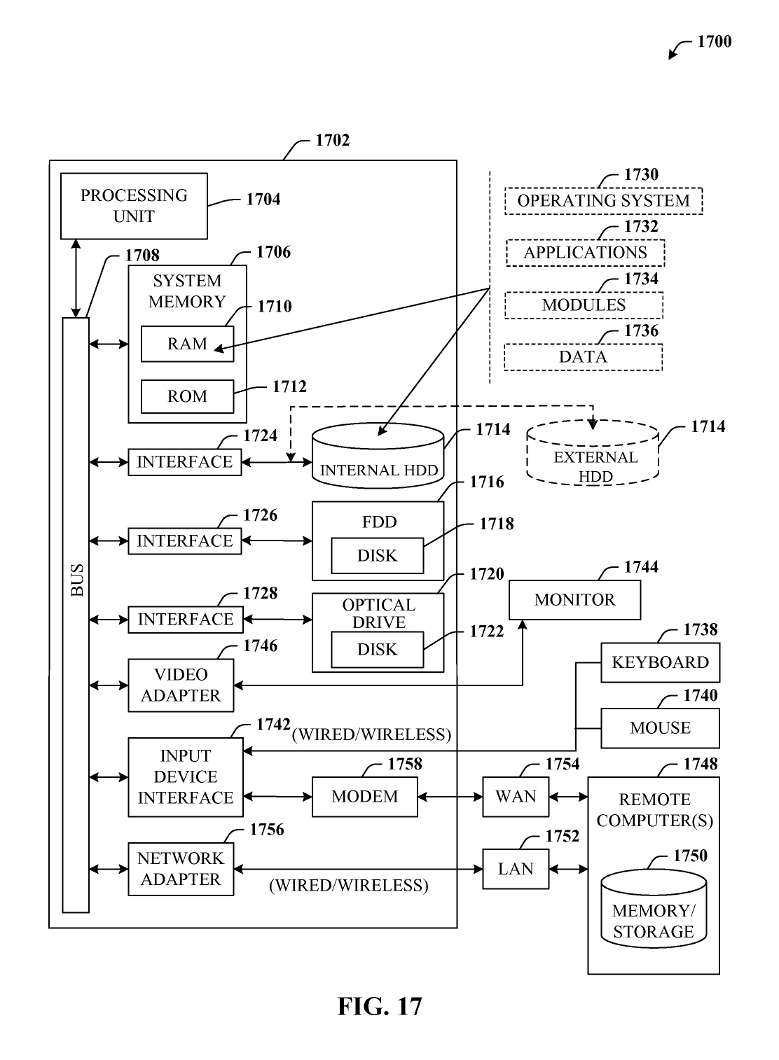

Referring now to FIG. 17, there is illustrated a block diagram of an exemplary computer system operable to execute the disclosed architecture. In order to provide additional context for various aspects of the claimed subject matter, FIG. 17 and the following discussion are intended to provide a brief, general description of a suitable computing environment 1700 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer readable media. Computer readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 17, the exemplary environment 1700 for implementing various aspects of the claimed subject matter includes a computer 1702, the computer 1702 including a processing unit 1704, a system memory 1706 and a system bus 1708. The system bus 1708 couples to system components including, but not limited to, the system memory 1706 to the processing unit 1704. The processing unit 1704 can be any of various commercially available processors. Dual microprocessors and other multi-processor architectures may also be employed as the processing unit 1704.

The system bus 1708 can be any of several types of bus structure that may further interconnect to a memory bus (with or without a memory controller), a peripheral bus, and a local bus using any of a variety of commercially available bus architectures. The system memory 1706 includes read-only memory (ROM) 1710 and random access memory (RAM) 1712. A basic input/output system (BIOS) is stored in a non-volatile memory 1710 such as ROM, EPROM, EEPROM, which BIOS contains the basic routines that help to transfer information between elements within the computer 1702, such as during start-up. The RAM 1712 can also include a high-speed RAM such as static RAM for caching data.

The computer 1702 further includes an internal hard disk drive (HDD) 1714 (e.g., EIDE, SATA), which internal hard disk drive 1714 may also be configured for external use in a suitable chassis (not shown), a magnetic floppy disk drive (FDD) 1716, (e.g., to read from or write to a removable diskette 1718) and an optical disk drive 1720, (e.g., reading a CD-ROM disk 1722 or, to read from or write to other high capacity optical media such as the DVD). The hard disk drive 1714, magnetic disk drive 1716 and optical disk drive 1720 can be connected to the system bus 1708 by a hard disk drive interface 1724, a magnetic disk drive interface 1726 and an optical drive interface 1728, respectively. The interface 1724 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. It is appreciated that the claimed subject matter can be implemented with various commercially available operating systems or combinations of operating systems.

A user can enter commands and information into the computer 1702 through one or more wired/wireless input devices, e.g. a keyboard 1738 and a pointing device, such as a mouse 1740. Other input devices (not shown) may include a microphone, an IR remote control, a joystick, a game pad, a stylus pen, touch screen, or the like. These and other input devices are often connected to the processing unit 1704 through an input device interface 1742 that is coupled to the system bus 1708, but can be connected by other interfaces, such as a parallel port, an IEEE1394 serial port, a game port, a USB port, an IR interface, etc.

A monitor 1744 or other type of display device is also connected to the system bus 1708 via an interface, such as a video adapter 1746. In addition to the monitor 1744, a computer typically includes other peripheral output devices (not shown), such as speakers, printers, etc.

The computer 1702 may operate in a networked environment using logical connections via wired and/or wireless communications to one or more remote computers, such as a remote computer(s) 1748. The remote computer(s) 1748 can be a workstation, a server computer, a router, a personal computer, a mobile device, portable computer, microprocessor-based entertainment appliance, a peer device or other common network node, and typically includes many or all of the elements described relative to the computer 1702, although, for purposes of brevity, only a memory/storage device 1750 is illustrated. The logical connections depicted include wired/wireless connectivity to a local area network (LAN) 1752 and/or larger networks, e.g. a wide area network (WAN) 1754. Such LAN and WAN networking environments are commonplace in offices and companies, and facilitate enterprise-wide computer networks, such as intranets, all of which may connect to a global communications network, e.g. the Internet.

When used in a LAN networking environment, the computer 1702 is connected to the local network 1752 through a wired and/or wireless communication network interface or adapter 1756. The adapter 1756 may facilitate wired or wireless communication to the LAN 1752, which may also include a wireless access point disposed thereon for communicating with the wireless adapter 1756.

When used in a WAN networking environment, the computer 1702 can include a modem 1758, or is connected to a communications server on the WAN 1754, or has other means for establishing communications over the WAN 1754, such as by way of the Internet. The modem 1758, which can be internal or external and a wired or wireless device, is connected to the system bus 1708 via the serial port interface 1742. In a networked environment, program modules depicted relative to the computer 1702, or portions thereof, can be stored in the remote memory/storage device 1750. It will be appreciated that the network connections shown are exemplary and other means of establishing a communications link between the computers can be used.

The computer 1702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 17 Mbps (802.11b) or 54 Mbps (802.11a) data rate, for example, or with products that contain both bands (dual band), so the networks can provide real-world performance similar to the basic “10 BaseT” wired Ethernet networks used in many offices.

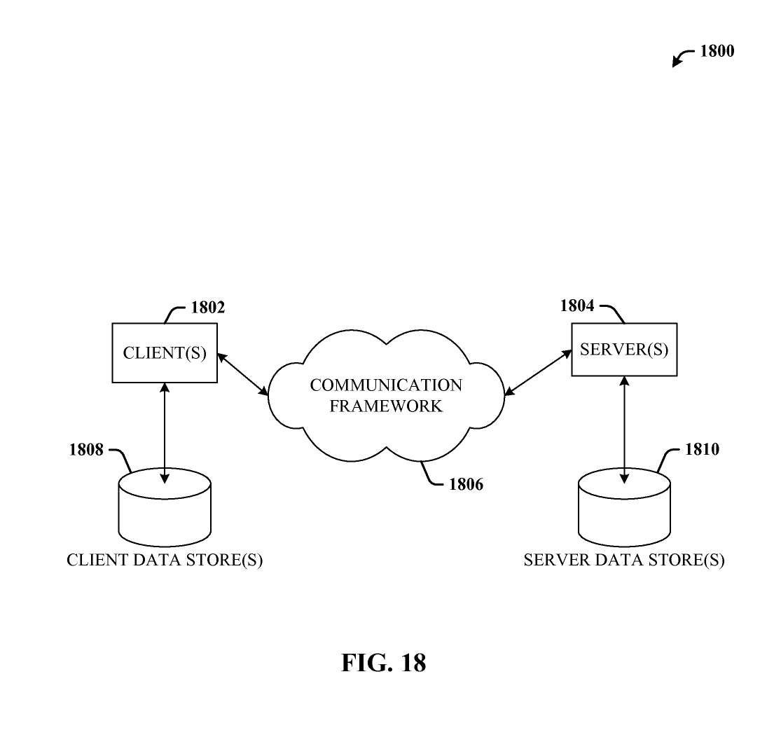

Referring now to FIG. 18, there is illustrated a schematic block diagram of an exemplary computer compilation system operable to execute the disclosed architecture. The system 1800 includes one or more client(s) 1802. The client(s) 1802 can be hardware and/or software (e.g., threads, processes, computing devices). The client(s) 1802 can house cookie(s) and/or associated contextual information by employing the claimed subject matter, for example.

The system 1800 also includes one or more server(s) 1804. The server(s) 1804 can also be hardware and/or software (e.g. threads, processes, computing devices). The servers 1804 can house threads to perform transformations by employing the claimed subject matter, for example. One possible communication between a client 1802 and a server 1804 can be in the form of a data packet adapted to be transmitted between two or more computer processes. The data packet may include a cookie and/or associated contextual information, for example. The system 1800 includes a communication framework 1806 (e.g., a global communication network such as the Internet) that can be employed to facilitate communications between the client(s) 1802 and the server(s) 1804.

Communications can be facilitated via a wired (including optical fiber) and/or wireless technology. The client(s) 1802 are operatively connected to one or more client data store(s) 1808 that can be employed to store information local to the client(s) 1802 (e.g. cookie(s) and/or associated contextual information). Similarly, the server(s) 1804 are operatively connected to one or more server data store(s) 1810 that can be employed to store information local to the servers 1804.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A display that is physically divisible, comprising:
a separable display with an anterior face that is configured as a user-interface (UI) for an associated multi-node computing component;
a plurality of computing nodes that are included in and distributed throughout the separable display, wherein a computing node from the plurality of computing nodes manages UI transactions associated with a local region of the separable display; and
the computing node includes a processor, a memory store, and a polling component that identifies physically coupled computing nodes included in the plurality of computing nodes.

2. The display of claim 1, the UI transactions managed by the computing node include at least one of an input transaction or an output transaction associated with the local region of the separable display.

3. The display of claim 1, the memory store that includes (1) a private memory allocation that is specific to the computing node or the associated local region of the separable display; and (2) public memory allocation that is accessible by disparate processors associated with the physically coupled computing nodes.

4. The display of claim 1, the polling component identifies capabilities of the physically coupled computing nodes.

5. The display of claim 1, the polling component identifies respective regions of the separable display in which the physically coupled computing nodes respectively manage UI transactions.

6. The display of claim 1, the polling component identifies a physically decoupled computing node.

7. The display of claim 6, the polling component identifies at least one of capabilities or physical geometry associated with the physically decoupled computing node, or a region of the separable display in which UI transactions are managed by the physically decoupled computing node.

8. The display of claim 1, the computing node further includes a synchronization component that facilitates data transfer between the memory store and disparate memory stores associated with the physically coupled computing nodes.

9. The display of claim 8, the synchronization component tags data propagated from a private memory allocation with an identifier associated with the computing node.

10. The display of claim 8, the synchronization component deletes data from the memory store that is tagged with an identifier associated with a physically decoupled computing node.

11. The display of claim 8, the synchronization component further facilitates normalization of processor utilization with respect to the processor and disparate processors associated with the physically coupled computing nodes.

12. The display of claim 1, the computing node further includes a power source.

13. The display of claim 12, the power source is a battery configured as a separable material strip that constitutes lateral edges of the separable display, or configured as a separable material plate coupled to a posterior face of the separable display.

14. The display of claim 12, the power source is a separable photovoltaic film that covers at least one of the anterior face or a posterior face of the separable display.

15. The display of claim 1 is printed on a surface by a printer.

16. A system that facilitates data mobility or collaboration in connection with a decomposable display, comprising:
a separable display that is configured as a UI for an associated computer-based device;
a synchronization component that manages memory for a memory store of an associated computing node of the device, and that facilitates data transfer between the memory store and a disparate memory store associated with a second computing node of the device;
a geometry component that identifies division boundaries when a physical portion of the separable display is decoupled from a remainder of the separable display;
a decomposition component that identifies a first subset of computing nodes included in the portion, and identifies a second set of computing nodes included in the remainder based upon the division boundaries.

17. The system of claim 16, the synchronization component manages memory for the memory store based upon UI transactions that occur in a region of the separable display managed by the computing node or physically coupled computing nodes, or based upon an object or data included in the region.

18. A computer implemented method for providing a decomposable display, comprising:
configuring a separable display as a UI for an associated distributed computing system;
embedding in the separable display a set of computing nodes that collectively constitutes the distributed computing system;
including in each computing node a processor, a memory, and a polling component configured for identifying other computing nodes physically attached to the separable display; and
configuring a computing node in the set for managing UI transactions in connection with a local region of the separable display proximal to the computing node.

19. The method of claim 18, further comprising at least one of the following acts:
replicating data included in the memory of a first computing node to the memory of a second computing node for enabling the second computing node to autonomously manage an associated second region of the separable display in the event of a decoupling of the first computing node and the second computing node;
replicating the data based upon manipulation of objects between a first region of the separable display associated with the first computing node and the second region;
tagging a private portion of replicated data with a node owner ID;
identifying division boundaries when a physical portion of the separable display is decoupled from a remainder of the separable display;
determining a set of capabilities of, a set of data available to, a physical location of, or a region of the separable display managed by computing nodes included in the portion or the remainder; or
deleting from computing nodes included in the portion replicated data tagged with a node owner ID associated with a computing node included in the remainder.

20. The method of claim 18, further comprising at least one of the following acts:
including in the separable display a power source configured to supply power to the separable display and the embedded set of computing nodes that constitute the distributed computing system;
configuring the power source as a separable material bezel around the separable display;
configuring the power source as a separable material cover attached to a posterior side of the separable display;
configuring the power source as a separable photovoltaic film that coats the posterior side or an anterior side of the separable display;
utilizing the power source included in a remainder of the separable display to wirelessly power a decoupled portion of the separable display; or
printing at least a portion of the separable display to a piece of paper, a piece of fabric, or a surface.
